(19) United States
(12) Patent Application Publication
(10) Pub. No.: US 2005/0138775 A1
(43) Pub. Date: Jun. 30, 2005

(54) Mobile computer compound hinge

(76) Inventor: Nicholas W. Oakley, Portland, OR (US)

Correspondence Address: JOHN P. WARD;BLAKELY, SOKOLOFF, TAYLOR & ZAFMAN LLP, 12400 WILSHIRE BOULEVARD, SEVENTH FLOOR, LOS ANGELES, CA, 90025-1026, US

(21) Appl. No.: 10/751,174

(22) Filed: Dec. 31, 2003

(51) Int. Cl. E05D 15/00

(52) U.S. Cl. 16/368

(57) ABSTRACT

An apparatus including a compound hinge. The apparatus includes a base, a lid, a first link pivotally coupled to the base and pivotally coupled to the lid; and a second link pivotally coupled the base and pivotally coupled to the lid, the first and second link positioned to position an edge of the display a distance from a first edge of the base towards a second opposite edge of the base, when the lid is in an unfolded position.

### FIELD OF INVENTION

The field of invention relates generally to data processing; and, more specifically, to a compound hinge for mobile computing devices.

### BACKGROUND

In many cases, when using a mobile computing device, space is a premium. For example, when using a laptop computer in an airline seat while the seat in the front has reclined, the space in which to operate the laptop on a folded down tray is very limited.

The typical mobile computer uses a simple pivot hinge situated at the rear of the computer. As illustrated in FIG. 1, when the computer 100 is opened, the space needed to operate the computer is increased by the amount the lid 102 of the computer 100 is displaced beyond the rear 106 of the base 104 of the computer.

As a result, there is a need to reduce the space needed to operate mobile computers. However, the base and display of a mobile computer typically have fixed dimensions and therefore are typically unable to be altered to reduce the space needed to operate mobile computers.

### BRIEF DESCRIPTION OF THE DRAWINGS

FIG. 1 presents an illustration of a prior art hinge for a mobile computing apparatus.

FIG. 2 presents an illustration of a compound hinge for a mobile computing apparatus in a closed position, according to one embodiment.

FIGS. 3a-c present illustrations of a compound hinge for a mobile computing apparatus in partly unfolded positions, according to one embodiment.

FIG. 4 presents an illustration of a compound hinge for a mobile computing apparatus in an unfolded position, according to one embodiment.

FIGS. 5a-b present illustrations of a compound hinge for a mobile computing apparatus, according to an alternative embodiment.

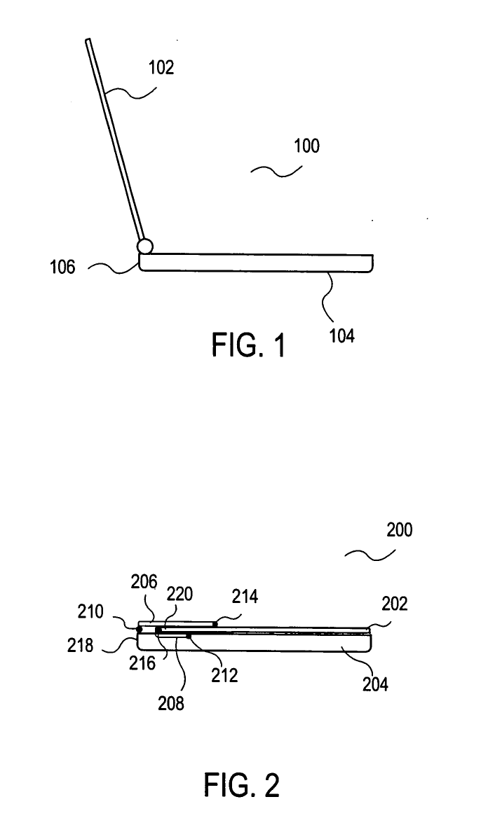

### DETAILED DESCRIPTION

A compound hinge is described. In one embodiment, the compound hinge is provided for mobile computing devices.

In the following description, numerous specific details are set forth. However, it is understood that embodiments may be practiced without these specific details. In other instances, well-known circuits, structures and techniques have not been shown in detail in order not to obscure the understanding of this description.

Reference throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. In addition, as described herein, a trusted platform, components, units, or subunits thereof, are interchangeably referenced as a protected or secured.

FIG. 2 illustrates one embodiment the compound hinge. As illustrated in FIG. 2, the compound hinge is implemented on apparatus having a lid 202 and a base 204. In one embodiment, the apparatus 200 may be a mobile computing device, with the lid including a display and the base including the data processing core.

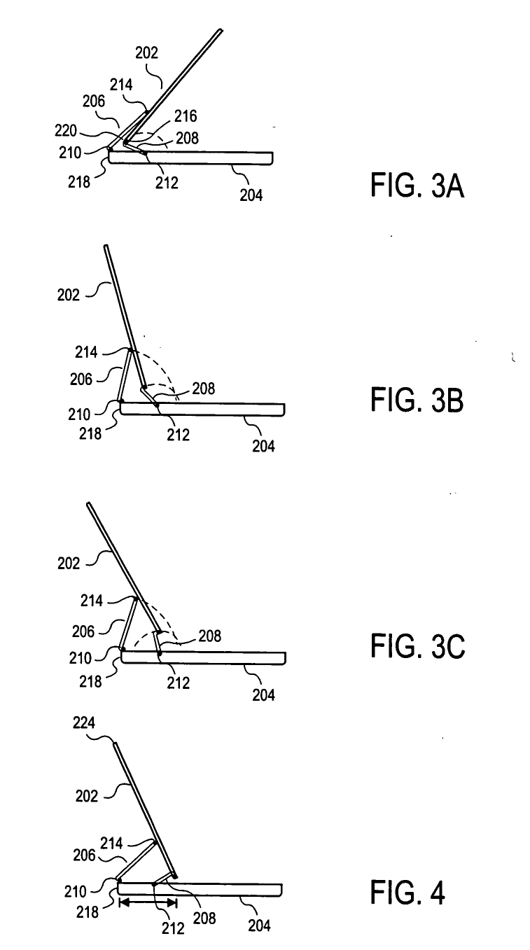

FIG. 2 illustrates the apparatus 200 in a closed position. As illustrated, the hinge consists of a first link 206 and a second link 208. The first link is pivotally coupled to the base 204 at a first axis of rotation 210, at a first edge 218 of the base, as further illustrated in FIGS. 3a-c. The second link 208 is pivotally coupled to the base about a second axis of rotation 212, at distance inward on the based from the first edge 218. The first link is also pivotally coupled to the lid 202 at a third axis of rotation 214, at distance inward on the lid from a bottom edge of the lid 220. The second link is also pivotally coupled to the lid at a fourth axis of rotation 216, at the bottom edge 220 of the lid. As further illustrated, in one embodiment, the first link has a first length and the second link has a second length, shorter than the first length.

FIGS. 3a-3c illustrate the apparatus 200, with the compound hinge, in partly unfolded positions. FIG. 4, illustrates the apparatus 200 in an unfolded position. In one embodiment, the unfolded position is when the lid has greater than a 90 degree angle relative to the base.

As illustrated in FIG. 4, the first 206 and second link 208 have a first and second length respectively, and are situated relative to the base 204 and lid 202 to allow the bottom edge 220 of the lid, when unfolded, to extend a distance inward away from the first edge 218 of the base 204 towards an opposite second edge 222 of the base. In one embodiment, in the unfolded position illustrated in FIG. 4, the bottom edge of the lid extends inward along the base 204 beyond the second axis of rotation 212, moving the lid 202 towards the second edge 222 of the base.

Furthermore, in one embodiment, as illustrated in FIG. 4, when in the unfolded position, a top edge 224 of the lid 202, opposite the bottom edge 220, does not extend beyond the first edge 218 of the base. As a result, when the apparatus 200 is in an unfolded position, additional space beyond the depth of the base 204 is not needed. In alternative embodiment, when in the unfolded position, the top edge 224 of the lid 202 may extend beyond the first edge 218 of the base.

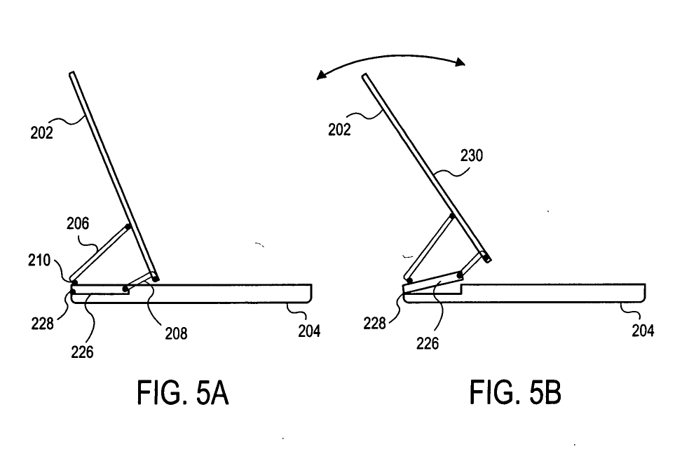

FIG. 5a illustrates an alternative embodiment of the compound hinge. As illustrated, the first link 206 and the second link 208 are pivotally coupled to a member section 226 of the base 204. The member section 226 is pivotally coupled to the base 204 about a fifth point of axis 228, or about the same axis 210 along the first edge 218 of the base. As a result, as illustrated in FIG. 5b, when the lid 202 is in the unfolded position, the member section 226 may be pivoted on the fifth axis 228 to allow a bottom surface 230 of the lid 202 face more upward.

In the foregoing specification, the invention has been described with reference to specific exemplary embodiments thereof. It will, however, be evident that various modifications and changes may be made thereto without departing from the broader spirit and scope of the invention as set forth in the appended claims. For example, in alternative embodiments, the compound hinge as described herein could be implemented with either pairs of links at either side of the display and base, or with single links that take the form of rectangles with hinges along their opposite edges that exist independently of the sides, on or about the centerline of the notebook, or even off center. The specification and drawings are, accordingly, to be regarded in an illustrative rather than a restrictive sense.

1. An apparatus comprising:
a base;
a lid;
a first link hinged to the base about a first axis, and hinged to the lid about a second axis; and
a second link hinged to the base about a third axis, and hinged to the lid about a fourth axis.

2. The apparatus of claim 1, the first and second link situated to position an edge of the display a distance from a first edge of the base towards a second opposite edge of the base, when the lid is in an unfolded position.

3. The apparatus of claim 1, wherein the first link is pivotally coupled to the first edge of the base, and the second link is pivotally coupled to the base between the first link and the second edge of the base.

4. The apparatus of claim 3, wherein, in the unfolded position, a distance between the first link pivotally coupled to the base and second link pivotally coupled to the base, is less than a distance between the bottom of the lid and the first edge of the base.

5. The apparatus of claim 4, wherein the apparatus is mobile computer system.

6. The apparatus of claim 5, wherein the first and second links are pivotally coupled to a member section of the base, the member section pivotally coupled to the base.

7. An apparatus comprising:
a base;
a lid;
a first link pivotally coupled to the base and pivotally coupled to the lid; and
a second link pivotally coupled the base and pivotally coupled to the lid, the first and second link positioned to position an edge of the display a distance from a first edge of the base towards a second opposite edge of the base, when the lid is in an unfolded position.

8. The apparatus of claim 7, wherein the first link has a length greater than the second link.

9. The apparatus of claim 8, wherein the first link is pivotally coupled to first edge of the base, and the second link is situated between the first link and the second edge of the base.

10. The apparatus of claim 9, wherein, in the unfolded position, a distance between the first link pivotally coupled to the base and second link pivotally coupled to the base, is less than a distance between the bottom of the lid and the first edge of the base.

11. The apparatus of claim 10, wherein the apparatus is mobile computer system.

12. The apparatus of claim 7, wherein the first and second links are pivotally coupled to a member section of the base, the member section pivotally coupled to the base.

13. The apparatus of claim 7, wherein the member section is pivotally coupled to the first edge of the base.

14. An apparatus comprising:
a base;
a lid;
a first link pivotally coupled to a first edge of the base and pivotally coupled to lid, a first distance from an edge of the lid; and
a second link pivotally coupled to the base, a second distance from the first link, and pivotally coupled to an edge of the lid.

15. The apparatus of claim 14, wherein the first link and second link are coupled to the base and lid, to position the edge of the lid a third distance from the first edge of the base towards a second opposite edge of the base, when the lid is in an unfolded position.

16. The apparatus of claim 15, wherein the apparatus is mobile computer system.

17. The apparatus of claim 16, wherein the first and second links are pivotally coupled to a member section of the base, the member section pivotally coupled to the base.
